(19) United States
(12) Patent Application Publication
(10) Pub. No.: US 2022/0238266 A1
(43) Pub. Date: Jul. 28, 2022

(54) SOFT MAGNETIC ALLOY, SOFT MAGNETIC ALLOY RIBBON, METHOD OF MANUFACTURING SOFT MAGNETIC ALLOY RIBBON, MAGNETIC CORE, AND COMPONENT

(71) Applicant: Hitachi Metals, Ltd., Tokyo (JP)

(72) Inventors: Yuichi Ogawa, Tokyo (JP); Naoki Itoh, Tokyo (JP); Takahiro Shiratake, Tokyo (JP); Motoki Ohta, Tokyo (JP)

(21) Appl. No.: 17/579,155

(22) Filed: Jan. 19, 2022

(30) Foreign Application Priority Data
Jan. 22, 2021 (JP) 2021-008348
Nov. 29, 2021 (JP) 2021-193545

(51) Int. Cl. H01F 1/153; H01F 41/02; H01F 27/25; C22C 45/02

(52) U.S. Cl. CPC H01F 1/15308; H01F 1/15333; C22C 45/02; H01F 41/0226; H01F 27/25; H01F 1/15341

(57) ABSTRACT

A soft magnetic alloy is represented by a composition formula (Fe₁₋ₓAₓ)ₐSi_{b}B_{c}Cu_{d}Mₑ, wherein A is at least one of Ni and Co, M is one or more selected from the group consisting of Nb, Mo, V, Zr, Hf, and W, and 82.4≤a≤86, 0.2≤b≤2.4, 12.5≤c≤15.0, 0.05≤d≤0.8, 0.4≤e≤1.0, and 0≤x≤0.1 in at %, and has a structure in which crystal grains having a grain size of 60 nm or less are present in an amorphous phase.

### CROSS-REFERENCE TO RELATED APPLICATIONS

This application claims priority based on Japanese Patent Application No. 2021-008348 filed with the Japanese Patent Office on Jan. 22, 2021 and Japanese Patent Application No. 2021-193545 filed with the Japanese Patent Office on Nov. 29, 2021, and the entire contents of Japanese Patent Application No. 2021-008348 and Japanese Patent Application No. 2021-193545 are incorporated herein by reference.

### BACKGROUND

The present disclosure relates to a soft magnetic alloy, a soft magnetic alloy ribbon, a method of manufacturing the same, a magnetic core, and a component.

Soft magnetic alloys having a nanocrystal structure have superior magnetic properties and are used in transformers, electronic components, motors, etc. Such transformers, electronic components, motors, etc. are required to be reduced in size and increased in efficiency. Thus, soft magnetic alloys used for such components (namely, transformers, electronic components, motors, etc.) are required to have further improved characteristics. Characteristics required for the soft magnetic alloys include high saturation magnetic flux density and low core loss. Among these components, many of them have been miniaturized by increasing the operating frequency as the frequency of semiconductors and the like increases, and Fe-based amorphous alloys and Fe-based nanocrystalline alloys having low core loss have attracted attention. In addition, there is a demand for soft magnetic alloys superior in price, productivity, and heat treatment performance in order to make soft magnetic alloys commercially popular.

WO 2018/025931 A (hereinafter also referred to as “Patent Document 1”) describes a method of manufacturing a soft magnetic material which achieves both high saturation magnetization and low coercive force by heating an alloy having a composition represented by a composition formula: Fe_{100-a-b-c}BₐCu_{b}M′_{c} in which M′ is at least one element selected from among Nb, Mo, Ta, W, Ni, and Co, the composition satisfies 10≤a≤16, 0<b≤2, and 0≤c≤8, and having an amorphous phase, at a rate of temperature rise of 10° C./sec. or more, and holding the alloy at a temperature equal to or higher than a crystallization onset temperature and lower than the generation onset temperature of a Fe—B compound for 0 to 80 seconds.

Japanese Unexamined Patent Application Publication No. 2019-94532 (hereinafter also referred to as “Patent Document 2”) discloses a soft magnetic alloy having a composition formula: ((Fe_{(1-(α+β))}X1_{α}X2_{β})_{(1-(a+b+c+d+e))}BₐSi_{b}C_{c}Cu_{d}Mₑ, wherein X1 is one or more selected from the group consisting of Co and Ni, X2 is one or more selected from the group consisting of Al, Mn, Ag, Zn, Sn, As, Sb, Bi, N, O and rare earth elements, M is one or more selected from the group consisting of Nb, Hf, Zr, Ta, Ti, Mo, W and V, 0.140<a≤0.240, 0≤b≤0.030, 0<c<0.080, 0<d≤0.020, 0≤e≤0.030, α≥0, β≥0, and 0≤α+β≤0.50. It is described that this soft magnetic alloy is a soft magnetic alloy having a high saturation magnetic flux density, a low coercive force, and a high magnetic permeability μ′ at the same time.

WO 2008/133301 A (hereinafter also referred to as “Patent Document 3”) discloses a soft magnetic alloy represented by Fe_{100-x-y-z}AₓM_{y}X_{z}, wherein A is at least one element selected from Cu and Au, M is at least one element selected from Ti, Zr, Hf, V, Nb, Ta, Cr, Mo, and W, X is at least one element selected from B and Si, 0<x≤5, 0.4≤y<2.5, and 10≤z≤20 in at %, and the soft magnetic alloy has a saturation magnetic flux density of 1.7 T or more and a coercive force of 15 A/m or less.

### SUMMARY

Patent Document 1 discloses a method of manufacturing a soft magnetic material having high saturation magnetization. However, the soft magnetic material described in Patent Document 1 does not contain Si. Therefore, with the soft magnetic material described in Patent Document 1, a SiO₂ film that contributes to corrosion resistance is not formed on a material surface, and thus it is difficult to prevent rust and the like.

The soft magnetic alloy described in Patent Document 2 does not have a very high saturation magnetic flux density (Bs). In general, as the amount of Fe increases, the saturation magnetic flux density increases, but in Example 6 where the amount of Fe is 84.0 at %, the saturation magnetic flux density (Bs) is 1.76 T. In addition, since this Example 6 does not contain Si, there is the above-described problem. In addition, the soft magnetic alloy described in Patent Document 2 is considered to have insufficient heat treatment performance because the amount of B is relatively large.

Since the soft magnetic alloy described in Patent Document 3 contains a large amount of expensive M element (Nb, etc.), the price increases. In addition, since anisotropy is imparted in the casting direction, and the ratio between a magnetic flux density produced when a magnetic field of 80 A/m is applied in the casting direction and a magnetic flux density produced when a magnetic field of 80 A/m is applied in a direction orthogonal to the casting direction is large, it is not suitable for applications requiring isotropy.

It is preferable that the present disclosure provides a soft magnetic alloy having a high saturation magnetic flux density and a low core loss, a soft magnetic alloy ribbon made of the soft magnetic alloy, a method of manufacturing the soft magnetic alloy ribbon, and a magnetic core and a component using the soft magnetic alloy ribbon.

Specific means for solving the above problems include following embodiments.

<1> A soft magnetic alloy represented by a composition formula (Fe₁₋ₓAₓ)ₐSibB_{c}Cu_{d}Mₑ, wherein A is at least one of Ni and Co, M is one or more selected from the group consisting of Nb, Mo, V, Zr, Hf, and W, and 82.4≤a≤86, 0.2≤b≤2.4, 12.5≤c≤15.0, 0.05≤d≤0.8, 0.4≤e≤1.0, and 0≤x≤0.1 in at %,

wherein the soft magnetic alloy has a structure in which crystal grains having a grain size of 60 nm or less are present in an amorphous phase.

<2> The soft magnetic alloy according to <1>, wherein the soft magnetic alloy has a saturation magnetic flux density of 1.74 T or more.

<3> The soft magnetic alloy according to <1> or <2>, wherein the soft magnetic alloy has a density of 7.45 g/cm³ or more.

<4> A soft magnetic alloy ribbon in which an alloy composition is represented by a composition formula (Fe₁₋ₓAₓ)ₐSi_{b}B_{c}Cu_{d}Mₑ, wherein A is at least one of Ni and Co, M is one or more selected from the group consisting of Nb, Mo, V, Zr, Hf, and W, and 82.4≤a≤86, 0.2≤b≤2.4, 12.5≤c≤15.0, 0.05≤d≤0.8, 0.4≤e≤1.0, and 0≤x≤0.1 in at %,

wherein the soft magnetic alloy ribbon has a structure in which crystal grains having a grain size of 60 nm or less are present in an amorphous phase, has a saturation magnetic flux density of 1.74 T or more, and exhibits a core loss of 25 W/kg or less at 1 kHz and 1 T.

<5> The soft magnetic alloy ribbon according to <4>, wherein the soft magnetic alloy ribbon has a density of 7.45 g/cm³ or more.

<6> The soft magnetic alloy ribbon according to <4> or <5>, wherein the soft magnetic alloy ribbon has a lamination factor of 86% or more.

<7> The soft magnetic alloy ribbon according to any one of <4> to <6>, wherein the soft magnetic alloy ribbon has a thickness of 25 μm or more.

<8> The soft magnetic alloy ribbon according to any one of <4> to <7>, wherein a ratio (L/W) of a value of a magnetic flux density L produced when a magnetic field of 80 A/m is applied in a casting direction of the soft magnetic alloy ribbon to a value of a magnetic flux density W produced when a magnetic field of 80 A/m is applied in a direction orthogonal to the casting direction of the soft magnetic alloy ribbon is 0.7 to 1.3.

<9> The soft magnetic alloy ribbon according to any one of <4> to <8>, wherein the soft magnetic alloy ribbon has a saturation magnetostriction of 20 ppm or less.

<10> A method of manufacturing the soft magnetic alloy ribbon according to any one of <4> to <9>, the method being a method of manufacturing a soft magnetic alloy ribbon having a structure in which crystal grains having a grain size of 60 nm or less are present in an amorphous phase by performing heat treatment of an alloy ribbon, wherein

in the heat treatment, where a temperature 10 to 140° C. lower than a bccFe crystallization onset temperature is defined as temperature T1 and a temperature 30 to 120° C. lower than a FeB compound precipitation onset temperature is defined as temperature T2, the alloy ribbon is

heated from room temperature to temperature T1 at a rate of temperature rise of 50° C./sec. or more,

heated from temperature T1 to temperature T2 at a rate of temperature rise that is less than the rate of temperature rise taken until temperature T1 and is equal to or less than 400° C./sec., and

after reaching temperature T2, cooled, or

after reaching temperature T2, held at a temperature between a temperature of T2-50° C. and temperature T2 for 0.5 to 60 seconds, and then cooled.

<11> The method of manufacturing a soft magnetic alloy ribbon according to <10>, wherein the alloy ribbon before the heat treatment is obtained by ejecting a molten alloy onto a rotating cooling roll and quenching the molten alloy to solidify on the cooling roll, and an outer peripheral portion of the cooling roll is made of a Cu alloy having a thermal conductivity of 120 W/(m K) or more.

<12> The method of manufacturing a soft magnetic alloy ribbon according to <10> or <11>, wherein when the density of the alloy ribbon before the heat treatment is M1 and the density of the alloy ribbon after the heat treatment is defined as M2, M2/M1 is 1.005 or more.

<13> A magnetic core constituted using the soft magnetic alloy ribbon according to any one of <4> to <9>.

<14> A component including the magnetic core according to <13> and a winding.

According to one embodiment of the present disclosure, a soft magnetic alloy and a soft magnetic alloy ribbon each having a high saturation magnetic flux density and a low core loss can be obtained. According to one embodiment of the present disclosure, a soft magnetic alloy ribbon having isotropy can be obtained. In addition, with a magnetic core and a component using a soft magnetic alloy ribbon of one embodiment of the present disclosure, a magnetic core and a component each having characteristics with a high saturation magnetic flux density and a low core loss can be obtained.

### BRIEF DESCRIPTION OF THE DRAWINGS

An example embodiment of the present disclosure will be described hereinafter by way of example with reference to the accompanying drawings, in which:

FIG. 1 is a diagram illustrating a heat treatment pattern example of one Example of the present disclosure and a heat treatment pattern of Reference Example;

FIG. 2 is a correlation diagram of a holding temperature, B₈₀₀₀, and a core loss of the sample heat-treated with the heat treatment pattern of Reference Example;

FIG. 3 is a correlation diagram of a holding temperature, B₈₀₀₀, and a core loss of the sample heat-treated with the heat treatment pattern of one Example of the present disclosure; and

FIG. 4 is a transmission electron microscope observation image of the No. 2 soft magnetic alloy ribbon of one Example of the present disclosure.

### DETAILED DESCRIPTION OF EXEMPLARY EMBODIMENTS

Embodiments of the present disclosure will be described in detail below. The present disclosure is not limited to the following embodiments at all, and can be implemented with appropriate modifications within the scope of the object of the present disclosure.

In the present disclosure, each numerical range specified using “to” represents a range including the numerical values indicated before and after “to” as the lower limit and the upper limit, respectively. In the numerical ranges described stepwise in the present disclosure, the upper limit or lower limit described in one numerical range may be replaced by the upper limit or lower limit of another numerical range described stepwise. In addition, in the numerical ranges described in the present disclosure, the upper limit or lower limit of the numerical ranges may be replaced by a value shown in Examples.

In the present disclosure, a combination of two or more preferred embodiments is a more preferred embodiment.

The soft magnetic alloy of the present disclosure is a soft magnetic alloy represented by a composition formula (Fe₁₋ₓAₓ)ₐSi_{b}B_{c}Cu_{d}Mₑ, wherein A is at least one of Ni and Co, M is one or more selected from the group consisting of Nb, Mo, V, Zr, Hf, and W, and 82.4≤a≤86, 0.2≤b≤2.4, 12.5≤c≤15.0, 0.05≤d≤0.8, 0.4≤e≤1.0, and 0≤x≤0.1 in at %,

wherein the soft magnetic alloy has a structure in which crystal grains having a grain size of 60 nm or less are present in an amorphous phase.

First, the composition of the present disclosure will be described in detail below.

The content of Fe (iron) is preferably 82.4% or more and 86% or less in at %.

By setting the content of Fe to 82.4% or more, it is possible to satisfy a saturation magnetic flux density of 1.74 T or more. The content of Fe is preferably 83% or more, more preferably 83.5% or more, and even more preferably 84% or more.

In addition, when the content of Fe is more than 86%, amorphization becomes difficult, and thus the content of Fe is set to 86% or less. The content of Fe is preferably 85.5% or less.

In the composition of the present disclosure, part of Fe may be substituted by at least one element of Ni and Co. This can be expressed by (Fe₁₋ₓAₓ), wherein A is at least one of Ni and Co, and x is 0.1 or less. x may be 0. When part of Fe is substituted by at least one element of Ni and Co, the above-described range of Fe can be read as the range of (Fe₁₋ₓAₓ). That is, (Fe₁₋ₓAₓ) is 82.4% or more and 86% or less in at %. (Fe₁₋ₓAₓ) is preferably 83% or more, more preferably 83.5% or more, and even more preferably 84% or more in at %. In addition, (Fe₁₋ₓAₓ) is preferably 85.5% or less in at %.

The content of Si (silicon) is 0.2% or more and 2.4% or less in at %.

By containing Si, an oxide film of SiO₂ having a thickness of several tens nm can be formed on an alloy surface. Thereby, the corrosion resistance of the soft magnetic alloy can be improved. In order to obtain the effect of improving corrosion resistance, Si is contained in an amount of 0.2% or more. The content of Si is preferably 1.0% or more.

When the content of Si is more than 2.4%, it becomes difficult to obtain a saturation magnetic flux density of 1.74 T or more, and it becomes difficult to increase the thickness of the soft magnetic alloy ribbon. For this reason, the content of Si is set to 2.4% or less. The content of Si is preferably 2.0% or less, and more preferably 1.9% or less.

The content of B (boron) is 12.5% or more and 15.0% or less in at %.

When the content of B is less than 12.5%, it becomes difficult to form an amorphous, and thus the content of B is set to 12.5% or more. The content of B is preferably 13.0% or more, and more preferably 13.5% or more.

When the content of B is more than 15.0%, the difference between the bccFe (αFe) crystallization onset temperature and the FeB compound precipitation onset temperature decreases, so that the range of an optimum heat treatment temperature is narrowed. For this reason, it becomes difficult to obtain a uniform and fine nanocrystal structure, and it becomes difficult to adjust the core loss at 1 T and 1 kHz to 25 W/kg or less. Thus, the content of B is set to 15.0% or less. The content of B is preferably 14.5% or less, more preferably 14.4% or less, and even more preferably 14.0% or less.

The content of Cu (copper) is 0.05% or more and 0.8% or less in at %.

When the content of Cu is less than 0.05%, it becomes difficult to obtain a uniform and fine nanocrystal structure, and it becomes difficult to adjust the core loss at 1 T and 1 kHz to 25 W/kg or less. For this reason, the content of Cu is set to 0.05% or more. The content of Cu is preferably 0.2% or more, more preferably 0.4% or more, and even more preferably 0.5% or more.

When the content of Cu is more than 0.8%, the soft magnetic alloy ribbon is easily embrittled, and it becomes difficult to increase the thickness of the soft magnetic alloy ribbon. For this reason, the content of Cu is set to 0.8% or less. The content of Cu is preferably 0.7% or less.

The element M is one or more selected from the group consisting of Nb, Mo, V, Zr, Hf, and W, and the content thereof is 0.4% or more and 1.0% or less in at %.

The M element can increase the onset temperature of precipitation of the FeB compound, which significantly deteriorates magnetic properties. As a result, the difference between the bccFe (αFe) crystallization onset temperature and the FeB compound precipitation onset temperature can be widened, the effect of widening the range of an optimum heat treatment temperature can be obtained, and the heat treatment conditions can be alleviated. For this reason, the M element is set to 0.4% or more. The content of the M element is preferably 0.42% or more, and more preferably 0.43% or more.

Since the M element is expensive, the price increases. For this reason, the content of the M element is preferably small. Thus, the content of the M element is set to 1.0% or less. The content of the element M is preferably 0.9% or less, more preferably 0.8% or less, even more preferably 0.7% or less, and further preferably 0.6% or less.

The soft magnetic alloy of the present disclosure may contain C (carbon). The content of C is preferably 1% by mass or less.

In addition, the soft magnetic alloy of the present disclosure may contain impurities other than C mentioned above in addition to the elements represented by the composition formula (Fe₁₋ₓAₓ)ₐSi_{b}B_{c}Cu_{d}Mₑ.

Examples of the impurities include S (sulfur), O (oxygen), N (nitrogen), Cr, Mn, P, Ti, and Al. For example, the content of S is preferably 200 ppm by mass or less, the content of O is preferably 5000 ppm by mass or less, and the content of N is preferably 1000 ppm by mass or less. The total content of the impurities is preferably 0.5 mass % or less. Elements corresponding to impurities may be added as long as their total content is within the above range.

The soft magnetic alloy of the present disclosure has a structure in which crystal grains having a grain size of 60 nm or less are present in an amorphous phase. The structure in which the crystal grains having a grain size of 60 nm or less are present in the amorphous phase is also referred to as a nanocrystal structure. A crystal having a grain size of 60 nm or less is also referred to as a nanocrystal.

In one aspect, the soft magnetic alloy of the present disclosure is characterized by having a nanocrystal structure.

In the soft magnetic alloy of the present disclosure, the proportion of nanocrystals is preferably 50% or more in volume fraction. As to this volume fraction, for example, nanocrystals and an amorphous phase are observed by observing an alloy cross section using a transmission electron microscope (TEM), and an approximate proportion of the nanocrystals can be calculated. That is, it is possible to determine whether or not the proportion of nanocrystals is 50% or more in volume fraction from the observed image described above.

When an alloy cross section is observed, the area ratio of crystal grains having a grain size of 60 nm or less in a specific visual field area is preferably 50% or more (a value obtained by setting the specific visual field area to 100%). Preferably, the soft magnetic alloy of the present disclosure includes crystal grains having a grain size of 60 nm or less and an amorphous phase and the area ratio of the crystal grains having a grain size of 60 nm or less is 50% or more. The area ratio can be determined by observing the alloy cross section using, for example, a transmission electron microscope (TEM) to observe crystal grains having a grain size of 60 nm or less and an amorphous phase.

The soft magnetic alloy of the present disclosure preferably has a saturation magnetic flux density of 1.74 T or more. The saturation magnetic flux density is more preferably 1.75 T or more, and even more preferably 1.77 T or more.

The soft magnetic alloy of the present disclosure preferably has a density of 7.45 g/cm³ or more. When the density is 7.45 g/cm³ or more, a high volume fraction of nanocrystals is obtained and a high saturation magnetic flux density is obtained.

The soft magnetic alloy of the present disclosure preferably has a core loss at 1 kHz and 1 T of 25 W/kg or less. The core loss is preferably 18 W/kg or less. The core loss is preferably 15 W/kg or less.

In addition, the soft magnetic alloy of the present disclosure preferably has a saturation magnetostriction of 20 ppm or less. Thereby, isotropy is easily obtained.

By the soft magnetic alloy of the present disclosure, a soft magnetic alloy having a high saturation magnetic flux density and a low core loss can be afforded.

The soft magnetic alloy of the present disclosure may be in the form of an alloy ribbon described below, a pulverized powder obtained by pulverizing the alloy ribbon, or a powder produced using an atomization method or the like.

The soft magnetic alloy ribbon of the present disclosure can be obtained by ejecting a molten alloy having the soft magnetic alloy composition described above onto a rotating cooling roll, quenching and solidifying the molten alloy on the cooling roll to obtain an alloy ribbon, and performing heat treatment of the alloy ribbon.

The molten alloy can be obtained, for example, by blending element sources (pure iron, ferroboron, ferrosilicon, etc.) for affording a target alloy composition, and then heating the mixture to a melting point or higher in an induction heating furnace or the like.

An alloy ribbon can be obtained by ejecting a molten alloy from a slit-shaped nozzle having a prescribed shape onto a rotating cooling roll, and then quenching and solidifying the molten alloy on the cooling roll. At this time, the cooling roll can have an outer diameter of 350 to 1000 mm, a width of 100 to 400 mm, and a peripheral speed of rotation of 20 to 35 m/s. The cooling roll preferably has therein a cooling mechanism (water cooling or the like) for suppressing a temperature rise of the outer peripheral portion.

The outer peripheral portion of the cooling roll is preferably made of a Cu alloy having a thermal conductivity of 120 W/(m K) or more. By setting the thermal conductivity of the outer peripheral portion of the cooling roll to 120 W/(m K) or more, the cooling rate when the molten alloy is cast into an alloy ribbon can be increased. This can suppress embrittlement of the alloy ribbon and can make thickening of the alloy ribbon possible. In addition, surface crystallization during casting can be suppressed, coarsening of crystal grains during heat treatment of the alloy ribbon can be suppressed, and the core loss can be reduced. The thickening is, for example, achieving a thickness of 15 μm or more, and preferably achieving a thickness of 20 μm or more.

The thermal conductivity of the outer peripheral portion of the cooling roll is preferably set to 150 W/(m K) or more, and more preferably set to 180 W/(m K) or more. In particular, when the thickness of the soft magnetic alloy ribbon is 30 μm or more, the thermal conductivity of the outer peripheral portion of the cooling roll is preferably set to 150 W/(m K) or more.

The outer peripheral portion of the cooling roll is a portion that comes into contact with a molten alloy, and the thickness thereof may be about 5 to 15 mm. A structural material that maintains a roll structure may be used inside the outer peripheral portion of the cooling roll.

The molten alloy is quenched and solidified on a cooling roll to afford an alloy ribbon and then the alloy ribbon is subjected to heat treatment, whereby a soft magnetic alloy ribbon having a nanocrystal structure can be obtained. When the heat treatment is performed, it is preferable to perform the heat treatment by raising the temperature of the alloy ribbon to a temperature equal to or higher than a bccFe (αFe) crystallization onset temperature and adjusting the temperature such that the alloy ribbon does not reach a FeB compound precipitation onset temperature.

Conventional heat treatment of an alloy ribbon has been performed, for example, by a heat treatment method in which the alloy ribbon is heated from room temperature to a temperature 30 to 100° C. lower than the FeB compound precipitation onset temperature at a rate of temperature rise of 10° C./sec or more and then held for several seconds.

However, in the case of an alloy ribbon in which Cu or Nb is reduced and the amount of Fe is increased in order to obtain a high saturation magnetic flux density, the temperature difference between the bccFe (αFe) crystallization onset temperature and the FeB compound precipitation onset temperature becomes small, and the range of the optimum heat treatment temperature becomes very narrow. For this reason, there is a problem that the heat treatment temperature (maximum temperature) needs to be adjusted in a narrow temperature range. In addition, in the case of manufacturing a wide alloy ribbon having a width of 50 mm or more, variations in the state of quenching and solidification in the width direction, variations in the thickness along the width direction, variations in the composition among lots, etc. occur, so that the range of the optimum heat treatment temperature is further narrowed, and there is a problem that it is difficult to perform uniform heat treatment in the entire alloy ribbon.

In the heat treatment of an alloy ribbon of the present disclosure, it is preferable that where a temperature 10 to 140° C. lower than a bccFe (αFe) crystallization onset temperature is defined as temperature T1 and a temperature 30 to 120° C. lower than a FeB compound precipitation onset temperature is defined as temperature T2, the alloy ribbon is heated from room temperature to temperature T1 at a rate of temperature rise of 50° C./sec. or more, heated from temperature T1 to temperature T2 at a rate of temperature rise that is less than the rate of temperature rise taken until temperature T1 and is equal to or less than 400° C./sec., and then cooled. After reaching temperature T2, the alloy ribbon may be cooled as it is, or after reaching temperature T2, the alloy ribbon may be held at a temperature between a temperature of T2-50° C. and temperature T2 for 0.5 to 60 seconds and then cooled.

Here, the rate of temperature rise is an average rate of temperature rise between the temperatures. For example, the rate of temperature rise from room temperature to temperature T1 can be calculated using a time (seconds) from room temperature to temperature T1 as a denominator and a temperature obtained by subtracting room temperature (25° C.) from temperature T1 as a numerator.

By the heat treatment method of an alloy ribbon of the present disclosure, a soft magnetic alloy ribbon having a high saturation magnetic flux density and a low core loss can be stably manufactured.

The heat treatment of an alloy ribbon of the present disclosure may also be performed after the alloy ribbon is processed into a magnetic core shape. The magnetic core shape may be a ribbon obtained by processing an alloy ribbon into a magnetic core shape by pressing or the like, a magnetic core obtained by laminating ribbons each having the magnetic core shape, a wound magnetic core constituted by winding a ribbon, or the like.

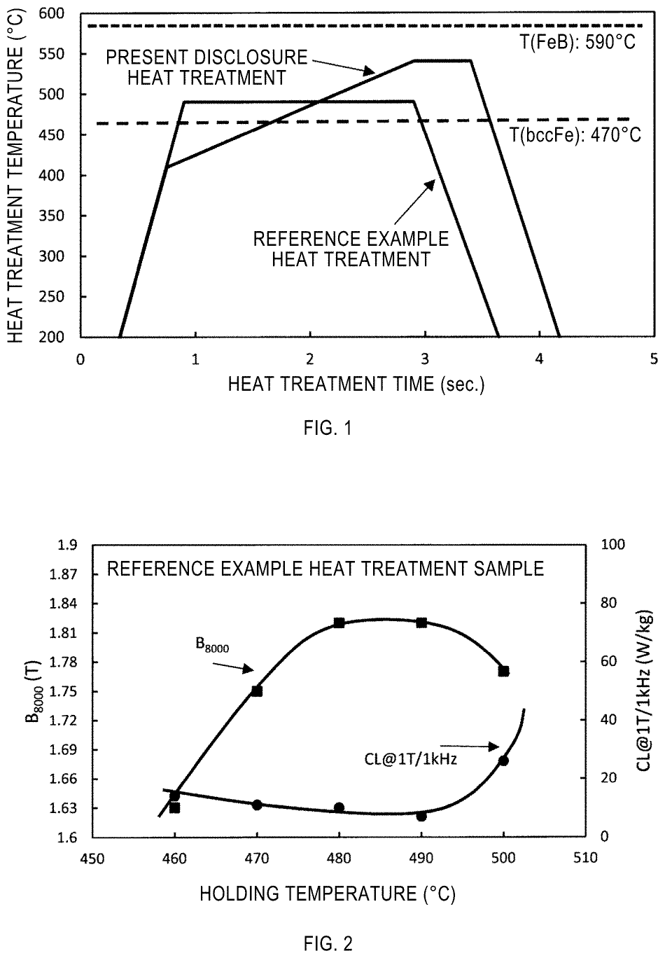

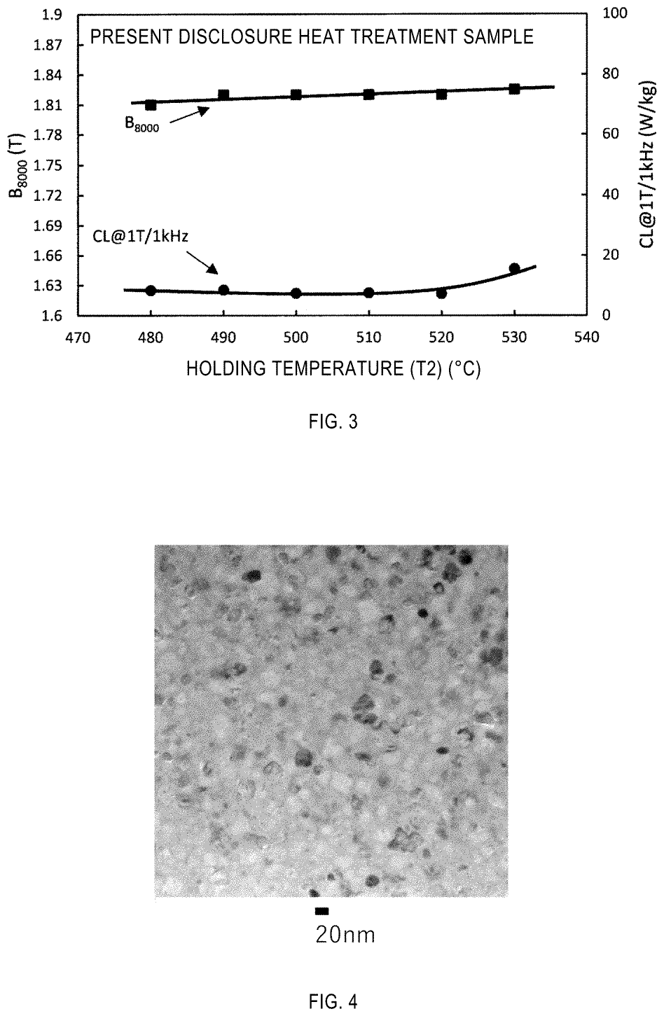

FIG. 1 shows a heat treatment pattern example of one Example of the present disclosure and Reference Example of a heat treatment pattern. FIG. 2 (reference examples of a heat treatment pattern) and FIG. 3 (one Example of the present disclosure) show the correlation of the holding temperature at that time as the X axis and the magnetic flux density B₈₀₀₀ produced when a magnetic field 8000 A/m is applied and the core loss (CL) at 1 T and 1 kHz as the Y axis. Table 1 (reference examples of a heat treatment pattern) and Table 2 (one Example of the present disclosure) show the heat treatment conditions at that time and the values of B₈₀₀₀ and core loss. The alloy composition of this sample is the same as No. 3 in Table 3 described below, the bccFe (αFe) crystallization onset temperature is 470° C., and the FeB compound precipitation onset temperature is 590° C. In FIG. 1 (and Tables 4 and 7), T(bccFe) denotes the bccFe crystallization onset temperature, and T(FeB) denotes the FeB compound precipitation onset temperature.

As shown in FIG. 2 and Table 1, in the heat treatment patterns of Reference Examples C1 to C5, when the holding temperature was 480° C. and 490° C., B₈₀₀₀ was 1.82 T, and when the holding temperature was 470° C. or lower and when the holding temperature was 500° C., B₈₀₀₀ was less than 1.82 T. When the holding temperature was 500° C., the core loss was significantly high. When the holding temperature was 480° C. and 490° C., B₈₀₀₀ was 1.82 T or more, and a low core loss was obtained. However, a temperature range in which B₈₀₀₀ was 1.82 T or more and a low core loss was obtained was about 10° C., which was very narrow.

On the other hand, as shown in FIG. 3 and Table 2, in the heat treatment patterns of Examples E1 to E6 of the present disclosure, temperature T1 is lower than the bccFe (αFe) crystallization onset temperature (470° C.) by 10° C., and temperatures T2 of E1, E2, E3, E4, E5, and E6 are lower than the FeB precipitation onset temperature (590° C.) by 110° C., 100° C., 90° C., 80° C., 70° C., and 60° C. in this order, respectively. In the heat treatment patterns E1 to E6, the holding time of T1 was 0 sec., and the holding time of T2 was 0.5 sec.

In the heat treatment patterns of Examples E1 to E6 of the present disclosure, when temperature T2 (holding temperature) was 490 to 530° C., B₈₀₀₀ was a high value of 1.82 to 1.83 T almost stably, and also when temperature T2 was 480° C., B₈₀₀₀ was a high value of 1.81 T. When temperature T2 (holding temperature) was 480 to 530° C., the core loss was 7.2 to 15.5 W/kg, showing a low core loss value. Accordingly, the temperature range of the holding temperature at which the B₈₀₀₀ was 1.82 T or more and the core loss was 25 W/kg or less was 40° C. or more, and the temperature range of the holding temperature at which the B₈₀₀₀ was 1.81 T or more and the core loss was 25 W/kg or less was 50° C. or more.

That is, in the case of the heat treatment pattern of the present disclosure, it was possible to obtain a soft magnetic alloy ribbon having a high saturation magnetic flux density and a low core loss in a wider temperature range than the reference examples.

The sample obtained by the heat treatment pattern of one Example of the present disclosure had a structure in which crystal grains having a grain size of 60 nm or less were present in an amorphous phase. In addition, when the cross section of each sample was observed, the area ratio of crystal grains having a grain size of 60 nm or less was 50% or more (a value obtained by setting the observation field area to 100%). In FIG. 3 and Table 2, the holding temperature is temperature T2.

TABLE 1

| | Holding | Rate of | Holding | | Core loss @ |
|---|---|---|---|---|---|
| | temperature | temperature | time | B₈₀₀₀ | 1 T/1 kHz |
| | (° C.) | rise (° C./sec.) | (sec.) | (T) | (W/kg) |
| C1 | 460 | 500 | 2 | 1.63 | 14 |
| C2 | 470 | 510 | 2 | 1.75 | 11 |
| C3 | 480 | 520 | 2 | 1.82 | 10 |
| C4 | 490 | 530 | 2 | 1.82 | 7 |
| C5 | 500 | 540 | 2 | 1.77 | 26 |

TABLE 2

| | | | | T1-T2 | | | |
|---|---|---|---|---|---|---|---|
| | | Temperature | | temperature | Holding | | Core loss @ |
| | T1 | rise rate to | T2 | rise rate | time | B₈₀₀₀ | 1 T/1 kHz |
| | (° C.) | T1 (° C./sec.) | (° C.) | (° C./sec.) | (sec.) | (T) | (W/kg) |
| E1 | 460 | 500 | 480 | 10 | 0.5 | 1.81 | 8.3 |
| E2 | 460 | 500 | 490 | 15 | 0.5 | 1.82 | 8.5 |
| E3 | 460 | 500 | 500 | 20 | 0.5 | 1.82 | 7.4 |
| E4 | 460 | 500 | 510 | 25 | 0.5 | 1.82 | 7.5 |
| E5 | 460 | 500 | 520 | 30 | 0.5 | 1.82 | 7.2 |
| E6 | 460 | 500 | 530 | 35 | 0.5 | 1.825 | 15.5 |

The rate of temperature rise taken during the heat treatment is preferably high from the viewpoint of productivity of a ribbon, the density of nuclei to be generated, and suppression of coarsening of the crystal grain size. However, if the rate of temperature rise is excessively large, crystallization occurs in a short time, so that the amount of heat generation per unit time increases and the temperature of the ribbon rises excessively, resulting in the following problems. Firstly, the ribbon reaches the FeB compound precipitation onset temperature, so that precipitation of the FeB compound is induced. Secondly, even when the ribbon does not reach the FeB compound precipitation onset temperature, the temperature rises excessively, so that the growth of the crystal grain size is accelerated and the core loss is deteriorated.

For this reason, in the heat treatment of the present disclosure, the rate of temperature rise is suppressed from the first temperature T1, so that precipitation of the FeB compound can be suppressed. In addition, by suppressing the rate of temperature rise from the first temperature T1, the growth of crystals is suppressed, so that variations in crystals can be suppressed. As a result, in the heat treatment of the present disclosure, it is possible to suppress an increase in core loss and to improve a shape defect such as wrinkles generated by a shrinkage difference during the heat treatment.

The rate of temperature rise taken from room temperature to temperature T1 is preferably as fast as possible, and is, for example, 50° C./sec. or more. The rate of temperature rise taken from room temperature to temperature T1 is preferably 200° C./sec. or more, more preferably 300° C./sec. or more, and even more preferably 400° C./sec. or more. The rate of temperature rise taken from room temperature to temperature T1 may be chosen according to equipment capacity.

The rate of temperature rise taken from temperature T1 to temperature T2 is set to be lower than the rate of temperature rise taken to temperature T1. For example, the rate of temperature rise taken from temperature T1 to temperature T2 is preferably lower than the rate of temperature rise taken to temperature T1 and equal to or less than 400° C./sec. The rate of temperature rise taken from temperature T1 to temperature T2 is preferably lower than the rate of temperature rise taken to temperature T1 and equal to or less than 200° C./sec., more preferably lower than the rate of temperature rise taken to temperature T1 and equal to or less than 150° C./sec., and even more preferably lower than the rate of temperature rise taken to temperature T1 and equal to or less than 100° C./sec. The rate of temperature rise taken from temperature T1 to temperature T2 is preferably 10° C./sec. or more, more preferably 30° C./sec. or more, and even more preferably 50° C./sec. or more.

The soft magnetic alloy ribbon of the present disclosure is, as described above, subjected to heat treatment at a high rate of temperature rise, and the heat treatment at a high rate of temperature rise is performed up to temperature T1 that is lower than the temperature at which the temperature rise due to crystallization of bccFe (αFe) starts. In addition, the rate of temperature rise taken after temperature T1 is set to be lower than the rate of temperature rise taken before and be 400° C./sec. or less. As a result, by controlling heat generation due to crystallization, precipitation of the FeB compound is suppressed and grain growth of αFe crystals is suppressed.

With the soft magnetic alloy ribbon of the present disclosure, by the heat treatment method of the present disclosure, the range of an optimum heat treatment temperature at which a high saturation magnetic flux density and a low core loss can be obtained can be widened, the temperature range to be controlled is widened, and a soft magnetic alloy ribbon having superior heat treatment performance can be obtained.

In the soft magnetic alloy ribbon of the present disclosure, when the density of the alloy ribbon before the heat treatment is defined as M1 and the density of the alloy ribbon after the heat treatment is defined as M2, M2/M1 is preferably 1.005 or more. By the heat treatment of the present disclosure described above, the density of the alloy ribbon can be improved. As a result, a high saturation magnetic flux density can be obtained.

The soft magnetic alloy ribbon of the present disclosure has a high saturation magnetic flux density and a low core loss. The saturation magnetic flux density is 1.74 T or more, and the core loss is 25 W/kg or less at 1 kHz and 1 T. The core loss is preferably 18 W/kg or less, and more preferably 15 W/kg or less. The saturation magnetic flux density is preferably 1.75 T or more, and more preferably 1.77 T or more.

The soft magnetic alloy ribbon of the present disclosure preferably has a density of 7.45 g/cm³ or more. When the density is 7.45 g/cm³ or more, a high volume fraction of nanocrystals is obtained and a high saturation magnetic flux density is obtained.

In addition, the soft magnetic alloy ribbon of the present disclosure preferably has a saturation magnetostriction of 20 ppm or less. Thereby, isotropy is easily obtained.

The soft magnetic alloy ribbon of the present disclosure has the configuration and characteristics of the soft magnetic alloy described above. Since their descriptions overlap, the above description is applied.

In addition, the soft magnetic alloy ribbon of the present disclosure preferably has a thickness of 15 μm or more, more preferably 20 μm or more, and the thickness is preferably 25 μm or more, and more preferably 30 μm or more. For example, when the thickness is 25 μm or more, it is possible to reduce the number of steps and the manufacturing cost when stacking the soft magnetic alloy ribbons to manufacture a magnetic core. The thickness is more preferably 32 μm or more. In addition, when the thickness of the soft magnetic alloy ribbon increases excessively, it becomes difficult to manufacture an alloy ribbon. For this reason, the thickness is preferably 50 μm or less. The thickness is more preferably 35 μm or less.

In addition, a soft magnetic alloy ribbon having a thickness of about 15 to 25 μm is preferable for applications in which it is necessary to lower the core loss in a high frequency band exceeding 1 kHz.

In addition, the soft magnetic alloy ribbon of the present disclosure can have a high lamination factor. In the soft magnetic alloy ribbon of the present disclosure, the lamination factor is preferably 86% or more. In addition, the soft magnetic alloy ribbon of the present disclosure preferably has a lamination factor of 88% or more. Due to such a high lamination factor, when the soft magnetic alloy ribbons are stacked, the lamination thickness can be reduced even with the same number of lamination as compared with an alloy ribbon having a low lamination factor, which contributes to downsizing of a magnetic core and downsizing of a component.

The lamination factor can be measured by the following method in accordance with JIS C 2534: 2017.

Twenty ribbons cut to a length of 120 mm are stacked, set on a flat sample stage, and a flat anvil having a diameter of 16 mm is placed on the ribbons stacked at a pressure of 50 kPa, and the height is measured at intervals of 10 mm in the width direction. Where the maximum height at that time is denoted by hmax (μm), a lamination factor LF is determined from the following calculation formula.

LF (%)=weight of sample(g)/density(g/cm³)/hmax(μm)/sample length(240 cm)/width of ribbon(cm)×10,000

At this time, the density (g/cm³) is the density of the alloy ribbon after the heat treatment.

In the soft magnetic alloy ribbon of the present disclosure, the ratio (L/W) of a value of a magnetic flux density L produced when a magnetic field of 80 A/m is applied in a casting direction of the soft magnetic alloy ribbon to a value of a magnetic flux density W produced when a magnetic field of 80 A/m is applied in a direction orthogonal to the casting direction of the soft magnetic alloy ribbon is preferably 0.7 to 1.3. When the ratio (L/W) is 0.7 to 1.3, a soft magnetic alloy ribbon having high isotropy can be obtained.

In general, anisotropy is introduced in the casting direction into an alloy ribbon produced by ejecting a molten alloy onto a rotating cooling roll and then quenching and solidifying the molten alloy. The casting direction is a direction along the rotation direction of the cooling roll, and is the longitudinal direction of an alloy ribbon continuously cast.

As described above, in the soft magnetic alloy ribbon in which the anisotropy in the casting direction is introduced at the time of casting, the introduced anisotropy also affects the characteristics after the heat treatment (after the heat treatment to form a nanocrystal structure). In particular, when the volume fraction of an amorphous phase is high, the magnetic flux density is different between the casting direction of the alloy ribbon (the longitudinal direction of the alloy ribbon) and the direction orthogonal to the casting direction (i.e., the direction orthogonal to the longitudinal direction, which corresponds to the width direction of the alloy ribbon), and anisotropy remains even after the heat treatment.

However, there are applications in which an isotropic soft magnetic alloy ribbon is required, such as motor applications. For this reason, it is preferable to perform heat treatment for increasing the volume fraction of nanocrystals such that the difference in magnetic flux density between the casting direction and the direction orthogonal to the casting direction falls within a certain range.

On the other hand, when the heat treatment temperature is set to a high temperature or the heat treatment time is extended in order to increase the volume fraction of nanocrystals, the FeB compound precipitates under certain conditions, so that the magnetic characteristics are deteriorated. In particular, a soft magnetic alloy ribbon having a large amount of Fe has a narrow range of an optimum heat treatment temperature for realizing isotropy, and there is a problem that it is difficult to obtain a soft magnetic alloy ribbon having a high saturation magnetic flux density, a low core loss, and isotropy and having a nanocrystal structure.

According to the present disclosure, it is possible to solve the above problems, to obtain a soft magnetic alloy ribbon having both a high saturation magnetic flux density and a low core loss while suppressing precipitation of a FeB compound, and to obtain a soft magnetic alloy ribbon further having isotropy.

In the soft magnetic alloy ribbon of the present disclosure, the range of the optimum heat treatment temperature for obtaining desired characteristics is wide, and mass productivity is high even in consideration of variations during mass production. In particular, in the case of a wide alloy ribbon to be used for a motor magnetic core or the like, temperature variation is likely to occur during heat treatment, and thus it is effective that the range of the optimum heat treatment temperature is wide.

In general, when a variation in rate of temperature rise or temperature occurs in the alloy ribbon, heat generation due to crystallization partially cannot be controlled, so that shrinkage during crystallization varies and wrinkles are generated in the alloy ribbon, and as a result defects easily occur such as a decrease in a lamination factor when the alloy ribbon is formed into a magnetic core.

However, in the soft magnetic alloy ribbon of the present disclosure, the allowable range for temperature variation during heat treatment is wide as described above, so that a soft magnetic alloy ribbon in which wrinkles are suppressed, a lamination factor is high, and smoothness is high can be obtained.

The smoothness can be defined by (hmax-hmin)/20 based on the maximum value hmax and the minimum value hmin of the thickness in the width direction measured at the time of lamination factor measurement. The smoothness is preferably 3 μm or less.

By using the soft magnetic alloy ribbon of the present disclosure to constitute a magnetic core to be used for a transformer, an electronic component, a motor, etc., a magnetic core having superior characteristics can be obtained.

In the case of constituting a magnetic core, the magnetic core can be constituted by cutting and stacking the alloy ribbons into a prescribed shape, winding the alloy ribbons, stacking and bending the alloy ribbons, and the like.

In addition, the soft magnetic alloy ribbon of the present disclosure may be pulverized into a powder, and the powder may be used to constitute a magnetic core. In addition, a powder made of the soft magnetic alloy of the present disclosure may be produced using an atomization method, and a magnetic core may be constituted using the powder.

In addition, by combining the magnetic core of the present disclosure and a winding to constitute a component such as a transformer, an electronic component, and a motor, a component having superior characteristics can be obtained. In this case, the magnetic core of the present disclosure may be combined with a magnetic core made of another magnetic material.

### EXAMPLES

### Example 1

Element sources were blended so as to afford each composition shown in Table 3, and heated to 1300° C. to prepare a molten alloy, and the molten alloy was ejected onto a cooling roll rotating at a peripheral speed of 30 m/s and having an outer diameter of 400 mm and a width of 200 mm, and quenched and solidified on the cooling roll to prepare an alloy ribbon. Each alloy ribbon was subjected to heat treatment under the heat treatment conditions shown in Table 4 to prepare a soft magnetic alloy ribbon. The width and thickness of the prepared alloy ribbon are shown in Table 3. The outer peripheral portion of the cooling roll is made of a Cu alloy having a thermal conductivity of 150 W/(m K), and a cooling mechanism for controlling the temperature of the outer peripheral portion is provided inside the cooling roll.

In Tables 3 and 4, Nos. 1 to 6 correspond to the soft magnetic alloy ribbon of the present disclosure, and Nos. 51 and 52 correspond to Comparative Examples. Tables 3 and 4 show B₈₀₀₀, the core loss at 1 T/1 kHz, the density, the bccFe (αFe) crystallization onset temperature T(bccFe), the FeB compound precipitation onset temperature T(FeB), temperature T1, temperature T2, the rate of temperature rise from room temperature to temperature T1, and the rate of temperature rise between T1 and T2 (T1-T2 temperature rise rate) for each sample. The rate of temperature rise from room temperature to temperature T1 was set to be 400 to 500° C./sec. The density is a density after the heat treatment.

Each of the samples of Nos. 1 to 6 had a structure in which crystal grains having a grain size of 60 nm or less were present in an amorphous phase. In addition, when the cross section of each sample was observed, the area ratio of crystal grains having a grain size of 60 nm or less was 50% or more (a value obtained by setting the observation field area to 100%).

[bccFe (αFe) Crystallization onset temperature, FeB compound precipitation onset temperature]

While the bccFe (αFe) crystallization onset temperature and the FeB compound precipitation onset temperature vary depending on the rate of temperature rise, the upper limit of the rate of temperature rise of a general thermal analyzer is about 2° C./sec. and the rate of temperature rise during the heat treatment of the present disclosure cannot be measured. Thus, values at a rate of temperature rise of 50° C./sec. were determined by the following method and taken as the bccFe (αFe) crystallization onset temperature and the FeB compound precipitation onset temperature.

The bccFe (αFe) crystallization onset temperature and the FeB compound precipitation onset temperature were measured at three points of a rate of temperature rise of 5° C./min. (0.083° C./sec.), 20° C./min. (0.333° C./sec.), and 50° C./min. (0.833° C./sec.) with DSC 8231 manufactured by Rigaku Corporation. The values were plotted with the logarithm of the rate of temperature rise as X-axis and the bccFe (αFe) crystallization onset temperature or the FeB compound precipitation onset temperature as Y-axis, and a value of the rate of temperature rise of 50° C./sec. was determined by extrapolation from the approximate curve.

Using the soft magnetic alloy ribbon after the heat treatment, the saturation magnetic flux density (B₈₀₀₀), core loss, and density were measured.

[Saturation Magnetic Flux Density (B₈₀₀₀)]

A magnetic field of 8000 A/m is applied to a heat-treated single sheet sample with DC magnetization characteristics test equipment manufactured by Metron Giken Co., Ltd., and the maximum magnetic flux density at that time is measured and taken as B₈₀₀₀. Since the soft magnetic alloy ribbon of the present disclosure has a characteristic of being relatively easily saturated, the soft magnetic alloy ribbon has been saturated at the time when the magnetic field 8000 A/m is applied, and the saturation magnetic flux density has substantially the same value as that of B₈₀₀₀. For this reason, the saturation magnetic flux density is represented by B₈₀₀₀.

[Core Loss]

The core loss of a single sheet sample after the heat treatment was measured under the conditions of a magnetic flux density of 1 T and a frequency of 1 kHz using AC magnetic measurement equipment TWM-18SR manufactured by Toei Industry Co., Ltd.

[Density]

A core-shaped sample having a size as large as the sample can be inserted into a sample cell having an outer diameter of 17 mm and a height of 33 mm was prepared by a constant volume expansion method using a dry densitometer AccuPyc 1330 manufactured by Shimadzu Corporation, and the volume of the sample was measured. A value obtained by dividing the weight of the core by the volume of the sample was calculated as a density.

TABLE 3

| | | | | | | | | | | Core loss |
|---|---|---|---|---|---|---|---|---|---|---|
| | Composition (at %) | | | | | | Width | Thickness | B₈₀₀₀ | 1 T/1 kHz |
| No. | Fe | Si | B | Nb | Mo | Cu | (mm) | (μm) | (T) | (W/kg) |
| 1 | 82.71 | 1.99 | 14.18 | 0.44 | — | 0.68 | 50 | 32 | 1.76 | 4.4 |
| 2 | 83.67 | 1.02 | 14.20 | 0.43 | — | 0.68 | 50 | 30 | 1.77 | 5.2 |
| 3 | 85.22 | 0.25 | 13.92 | 0.41 | — | 0.2 | 50 | 28 | 1.82 | 7.2 |
| 4 | 83.71 | 0.44 | 14.36 | 0.80 | — | 0.69 | 50 | 23 | 1.75 | 3.1 |
| 5 | 83.07 | 2.20 | 13.60 | 0.45 | — | 0.68 | 85 | 30 | 1.77 | 6.0 |
| 6 | 82.68 | 1.99 | 14.18 | 0.44 | — | 0.71 | 50 | 28 | 1.74 | 7.0 |
| 51 | 81.60 | 3.72 | 13.64 | — | 0.19 | 0.85 | 50 | 24 | 1.73 | 6.7 |
| 52 | 85.96 | 0.16 | 13.85 | 0.01 | — | 0.02 | 50 | 32 | 1.85 | 19.0 |

TABLE 4

| | | | | | | Temperature rise | T1-T2 |
|---|---|---|---|---|---|---|---|
| | | | | | | rate from room | temperature |
| | Density | T(bccFe) | T(FeB) | T1 | T2 | temperature to T1 | rise rate |
| No. | (g/cm³) | (° C.) | (° C.) | (° C.) | (° C.) | (° C./sec.) | (° C./sec.) |
| 1 | 7.45 | 510 | 610 | 450 | 540 | 490 | 30 |
| 2 | 7.51 | 490 | 600 | 450 | 540 | 490 | 30 |
| 3 | 7.52 | 470 | 590 | 460 | 520 | 500 | 20 |
| 4 | 7.50 | 490 | 610 | 430 | 520 | 470 | 30 |
| 5 | 7.49 | 510 | 620 | 430 | 520 | 470 | 30 |
| 6 | 7.48 | 520 | 610 | 430 | 560 | 470 | 60 |
| 51 | 7.42 | 530 | 610 | 410 | 540 | 450 | 60 |
| 52 | 7.53 | 470 | 570 | 370 | 500 | 410 | 130 |

In Examples of the present disclosure (Nos. 1 to 6), high saturation magnetic flux densities and low core losses were obtained. The density was 7.45 g/cm³ or more.

Comparative Example No. 51 has a low saturation magnetic flux density.

Comparative Example No. 52 had a slightly high core loss, but the characteristic values were almost the same as those of Examples of the present disclosure. However, since the content of Si was small, rust occurred after several days of storage in the atmosphere, and a problem in handling occurred.

For the samples of Nos. 1 to 6 and Nos. 51 and 52, in Table 5 are shown the ratio (L/W) of the values of the magnetic flux density L produced when a magnetic field of 80 A/m is applied in the casting direction and the magnetic flux density W produced when a magnetic field of 80 A/m is applied in the direction orthogonal to the casting direction, and M2/M1 when the density of an alloy ribbon before heat treatment is defined as M1 and the density of the alloy ribbon after the heat treatment is defined as M2.

[Magnetic Flux Density L, W]

Using a DC magnetization characteristics test equipment manufactured by Metron Giken Co., Ltd., a magnetic field of 80 A/m was applied in each of the casting direction and the direction orthogonal to the casting direction of a single sheet sample after the heat treatment. Where the maximum magnetic flux densities at that time are denoted by L and W, respectively, the isotropy was evaluated by a ratio L/W of L to W.

In Examples (Nos. 1 to 6) of the present disclosure, the ratio (L/W) was in the range of 0.7 to 1.3, that is, soft magnetic alloy ribbons having high isotropy were obtained, and the density ratio (M2/M1) was 1.005 or more.

In Nos. 51 and 52 of Comparative Examples, the ratio (L/W) was more than 1.3.

TABLE 5

| | | | Saturation |
|---|---|---|---|
| | | | magnetostriction |
| No. | L/W | M2/M1 | (ppm) |
| 1 | 0.70 | 1.010 | 12.2 |
| 2 | 0.73 | 1.008 | 13.4 |
| 3 | 0.76 | 1.009 | 8.7 |
| 4 | 1.06 | 1.010 | 10.3 |
| 5 | 0.95 | 1.012 | 14.0 |
| 6 | 1.20 | 1.007 | 12.4 |
| 51 | 1.36 | 1.012 | 12.8 |
| 52 | 1.41 | 1.007 | 11.2 |

The values of the saturation magnetostrictions of Nos. 1 to 5 are shown in Table 5.

[Saturation Magnetostriction]

A magnetic field of 5 kOe was applied to a sample, to which a strain gauge manufactured by Kyowa Electronic Instruments Co., Ltd. had been attached, by an electromagnet, and the electromagnet was rotated by 360° to change the direction of the magnetic field applied to the sample by 360°. The maximum amounts of change in elongation and shrinkage of the sample were measured from the change in electric resistance value of the strain gauge. The saturation magnetostriction was defined by ⅔× the maximum amount of change.

In Examples of the present disclosure, the saturation magnetostriction was 20 ppm or less.

A cross-sectional observation photograph of the No. 2 soft magnetic alloy ribbon is shown in FIG. 4. FIG. 4 is a transmission electron microscope observation image (TEM image) observed by a transmission electron microscope. As shown in FIG. 4, the soft magnetic alloy ribbon of the present disclosure has a structure including nanocrystals having a grain size of 20 to 30 nm, and since the nanocrystal grains occupy half or more of the observed cross section, it was confirmed that the volume fraction of nanocrystals was 50% or more.

### Example 2

Element sources were blended so as to afford a composition of Fe_{83.07}Si_{2.20}B_{13.60}Nb_{0.45}Cu_{0.68}, and a molten alloy heated to 1300° C. was ejected onto a cooling roll rotating at a peripheral speed of 30 m/s and having an outer diameter of 400 mm and a width of 300 mm, and quenched and solidified on the cooling roll to prepare an alloy ribbon. Each alloy ribbon was subjected to heat treatment under the heat treatment conditions shown in Table 7 to prepare a soft magnetic alloy ribbon. The width and thickness of the prepared alloy ribbon are shown in Table 6. The outer peripheral portion of the cooling roll is made of a Cu alloy having a thermal conductivity of 150 W/(m·K), and a cooling mechanism for controlling the temperature of the outer peripheral portion is provided inside the cooling roll.

Each of the samples of Nos. 7 to 9 of the Example of the present disclosure had a structure in which crystal grains having a grain size of 60 nm or less were present in an amorphous phase. In addition, when the cross section of each sample was observed, the area ratio of crystal grains having a grain size of 60 nm or less was 50% or more (a value obtained by setting the observation field area to 100%).

The heat treatment conditions of each sample, the lamination factor, smoothness, B₈₀₀₀, core loss, and density of the samples after heat treatment were measured, and the results are shown in Tables 6 and 7.

Nos. 53 and 54 are comparative examples. No. 53 is a sample prepared under a heat treatment condition in which temperature T2 is 150° C. lower than the FeB compound precipitation onset temperature, and No. 54 is a sample prepared under a heat treatment condition in which temperature T2 is 20° C. lower than the FeB compound precipitation onset temperature, and the resulting values are also shown in Tables 6 and 7. In the sample No. 53, B₈₀₀₀ was as low as 1.73 T, and the heat treatment was insufficient. In the sample No. 54, the core loss significantly increased, and the core loss could not be measured under the conditions of 1 T and 1 kHz. From this, No. 54 is considered to be characteristic deterioration due to precipitation of the FeB compound. In the sample No. 54, wrinkles were generated during the heat treatment, so that the lamination factor was degraded to 79% and the smoothness was degraded to 3.5 μm.

In Examples (Nos. 7 to 9) of the present disclosure, the saturation magnetic flux density was high, the core loss was low, and the lamination factor was 86% or more. In addition, the density was high and the smoothness was also good.

TABLE 6

| | | | | | | | | | Lamination | | |
|---|---|---|---|---|---|---|---|---|---|---|---|
| | Composition (at %) | | | | | | Width | Thickness | factor | Smoothness | B₈₀₀₀ |
| No. | Fe | Si | B | Nb | Mo | Cu | (mm) | (μm) | (%) | (μm) | (T) |
| 7 | 83.07 | 2.20 | 13.60 | 0.45 | — | 0.68 | 85 | 27 | 86.0 | 1.5 | 1.77 |
| 8 | 83.07 | 2.20 | 13.60 | 0.45 | — | 0.68 | 85 | 30 | 88.0 | 1.8 | 1.77 |
| 9 | 83.07 | 2.20 | 13.60 | 0.45 | — | 0.68 | 85 | 32 | 87.0 | 2.0 | 1.77 |
| 53 | 83.07 | 2.20 | 13.60 | 0.45 | — | 0.68 | 85 | 27 | 86.0 | 1.5 | 1.73 |
| 54 | 83.07 | 2.20 | 13.60 | 0.45 | — | 0.68 | 85 | 27 | 79.0 | 3.5 | 1.78 |

TABLE 7

| | | | | | | | Temperature rise | T1-T2 |
|---|---|---|---|---|---|---|---|---|
| | Core loss | | | | | | rate from room | temperature |
| | 1 T/1 kHz | Density | T(bccFe) | T(FeB) | T1 | T2 | temperature to | rise rate |
| No. | (W/kg) | (g/cm³) | (° C.) | (° C.) | (° C.) | (° C.) | T1 (° C./sec.) | (° C./sec.) |
| 7 | 6.0 | 7.49 | 510 | 620 | 430 | 520 | 430 | 30 |
| 8 | 6.6 | 7.49 | 510 | 620 | 430 | 520 | 430 | 30 |
| 9 | 7.0 | 7.49 | 510 | 620 | 430 | 520 | 430 | 30 |
| 53 | 5.0 | 7.44 | 510 | 620 | 410 | 470 | 440 | 20 |
| 54 | could not | 7.51 | 510 | 620 | 490 | 600 | 530 | 35 |
| | be measured | | | | | | | |

[Lamination Factor]

The measurement was performed by the following method in accordance with JIS C 2534: 2017.

Twenty ribbons cut to a length of 120 mm are stacked, set on a flat sample stage, and a flat anvil having a diameter of 16 mm is placed on the ribbons stacked at a pressure of 50 kPa, and the height is measured at intervals of 10 mm in the width direction. Where the maximum height at that time is denoted by hmax (μm), a lamination factor LF is determined from the following calculation formula.

LF (%)=weight of sample(g)/density(g/cm³)/hmax(μm)/sample length(240 cm)/width of ribbon(cm)×10,000

As described above, according to the present disclosure, soft magnetic alloy ribbons having a high saturation magnetic flux density and a low core loss were obtained. In addition, according to the present disclosure, soft magnetic alloy ribbons having suppressed anisotropy and having isotropy were obtained. In addition, according to the present disclosure, soft magnetic alloy ribbons having a high density, a high lamination factor, and good smoothness were obtained. The soft magnetic alloy ribbon of the present disclosure is one form of the soft magnetic alloy of the present disclosure.

When the soft magnetic alloy ribbon of the present disclosure is used to constitute a magnetic core, a known means can be used to constitute the magnetic core. As a magnetic core constituted using the soft magnetic alloy ribbon of the present disclosure, a magnetic core having a high saturation magnetic flux density, a low core loss and isotropy possessed by the soft magnetic alloy ribbon of the present disclosure is constituted, and a magnetic core having superior characteristics is obtained.

Moreover, by constituting a component including a winding and a magnetic core constituted using the soft magnetic alloy ribbon of the present disclosure, a component having a high saturation magnetic flux density, a low core loss and isotropy possessed by the soft magnetic alloy ribbon of the present disclosure is constituted, and a component having superior characteristics is obtained.

What is claimed is:

1. A soft magnetic alloy represented by a composition formula (Fe₁₋ₓAₓ)ₐSi_{b}B_{c}Cu_{d}Mₑ, wherein A is at least one of Ni and Co, M is one or more selected from the group consisting of Nb, Mo, V, Zr, Hf, and W, and 82.4≤a≤86, 0.2≤b≤2.4, 12.5≤c≤15.0, 0.05≤d≤0.8, 0.4≤e≤1.0, and 0≤x≤0.1 in at %,
wherein the soft magnetic alloy has a structure in which crystal grains having a grain size of 60 nm or less are present in an amorphous phase.

2. The soft magnetic alloy according to claim 1, wherein the soft magnetic alloy has a saturation magnetic flux density of 1.74 T or more.

3. The soft magnetic alloy according to claim 1, wherein the soft magnetic alloy has a density of 7.45 g/cm³ or more.

4. A soft magnetic alloy ribbon in which an alloy composition is represented by a composition formula (Fe₁₋ₓAₓ)ₐSi_{b}B_{c}Cu_{d}Mₑ, wherein A is at least one of Ni and Co, M is one or more selected from the group consisting of Nb, Mo, V, Zr, Hf, and W, and 82.4≤a≤86, 0.2≤b≤2.4, 12.5≤c≤15.0, 0.05≤d≤0.8, 0.4≤e≤1.0, and 0≤x≤0.1 in at %,
wherein the soft magnetic alloy ribbon has a structure in which crystal grains having a grain size of 60 nm or less are present in an amorphous phase, has a saturation magnetic flux density of 1.74 T or more, and exhibits a core loss of 25 W/kg or less at 1 kHz and 1 T.

5. The soft magnetic alloy ribbon according to claim 4, wherein the soft magnetic alloy ribbon has a density of 7.45 g/cm³ or more.

6. The soft magnetic alloy ribbon according to claim 4, wherein the soft magnetic alloy ribbon has a lamination factor of 86% or more.

7. The soft magnetic alloy ribbon according to claim 4, wherein the soft magnetic alloy ribbon has a thickness of 25 μm or more.

8. The soft magnetic alloy ribbon according to claim 4, wherein a ratio (L/W) of a value of a magnetic flux density L produced when a magnetic field of 80 A/m is applied in a casting direction of the soft magnetic alloy ribbon to a value of a magnetic flux density W produced when a magnetic field of 80 A/m is applied in a direction orthogonal to the casting direction of the soft magnetic alloy ribbon is 0.7 to 1.3.

9. The soft magnetic alloy ribbon according to claim 4, wherein the soft magnetic alloy ribbon has a saturation magnetostriction of 20 ppm or less.

10. A method of manufacturing the soft magnetic alloy ribbon according to claim 4, the method being a method of manufacturing a soft magnetic alloy ribbon having a structure in which crystal grains having a grain size of 60 nm or less are present in an amorphous phase by performing heat treatment of an alloy ribbon, wherein
in the heat treatment, where a temperature 10 to 140° C. lower than a bccFe crystallization onset temperature is defined as temperature T1 and a temperature 30 to 120° C. lower than a FeB compound precipitation onset temperature is defined as temperature T2, the alloy ribbon is
heated from room temperature to temperature T1 at a rate of temperature rise of 50° C./sec. or more,
heated from temperature T1 to temperature T2 at a rate of temperature rise that is less than the rate of temperature rise taken until temperature T1 and is equal to or less than 400° C./sec., and
after reaching temperature T2, cooled, or
after reaching temperature T2, held at a temperature between a temperature of T2-50° C. and temperature T2 for 0.5 to 60 seconds, and then cooled.

11. The method of manufacturing a soft magnetic alloy ribbon according to claim 10, wherein the alloy ribbon before the heat treatment is obtained by ejecting a molten alloy onto a rotating cooling roll and quenching the molten alloy to solidify on the cooling roll, and an outer peripheral portion of the cooling roll is made of a Cu alloy having a thermal conductivity of 120 W/(m·K) or more.

12. The method of manufacturing a soft magnetic alloy ribbon according to claim 10, wherein when the density of the alloy ribbon before the heat treatment is M1 and the density of the alloy ribbon after the heat treatment is defined as M2, M2/M1 is 1.005 or more.

13. A magnetic core constituted using the soft magnetic alloy ribbon according to claim 4.

14. A component comprising the magnetic core according to claim 13 and a winding.
